(19) United States
(12) Patent Application Publication
(10) Pub. No.: US 2013/0130022 A1
(43) Pub. Date: May 23, 2013

(54) MEMBER FOR ELECTROPHOTOGRAPHY, PROCESS CARTRIDGE, AND ELECTROPHOTOGRAPHIC APPARATUS

(71) Applicant: CANON KABUSHIKI KAISHA, Tokyo (JP)

(72) Inventors: Tomoya Uesugi, Susono-shi (JP); Seiji Tsuru, Susono-shi (JP); Kazutoshi Ishida, Mishima-shi (JP); Hidenori Satoh, Odawara-shi (JP)

(73) Assignee: CANON KABUSHIKI KAISHA, Tokyo (JP)

(21) Appl. No.: 13/742,176

(22) Filed: Jan. 15, 2013

Related U.S. Application Data
(63) Continuation of application No. PCT/JP2012/005977, filed on Sep. 20, 2012.

(30) Foreign Application Priority Data
Oct. 14, 2011 (JP) 2011-226869

(51) Int. Cl. C09D 5/00; G03G 7/00

(52) U.S. Cl. CPC C09D 5/00; G03G 7/00
USPC 428/336; 399/111; 428/702; 428/523; 428/447; 428/424.8; 428/425.5

(57) ABSTRACT

Provided are a member for electrophotography whose charge-providing performance for toner is stable even under a high-humidity environment, and a process cartridge and an electrophotographic apparatus each using the member for electrophotography. Specifically, provided are a member for electrophotography including a mandrel, an elastic layer, and a protective layer, in which the protective layer is a zinc oxide film containing both formula 1 —Zn—O—R (in the formula 1, R represents an alkyl group) and formula 2 —O—Zn—O—, and a process cartridge and an electrophotographic apparatus each using the member for electrophotography.

### CROSS-REFERENCE TO RELATED APPLICATIONS

This application is a continuation of International Application No. PCT/JP2012/005977, filed Sep. 20, 2012, which claims the benefit of Japanese Patent Application No. 2011-226869, filed Oct. 14, 2011.

### BACKGROUND OF THE INVENTION

1. Field of the Invention

The present invention relates to a member for electrophotography to be used in, for example, a developing member or a charging member, and a process cartridge and an electrophotographic apparatus each using the member.

2. Description of the Related Art

In recent years, an electrophotographic apparatus has been required to have various kinds of performance, and a member for electrophotography (conductive roller for electrophotography) such as a developing roller or a charging roller has also been required to have many functions.

Japanese Patent Application Laid-Open No. 2009-037135 discloses, as a member for an image-forming apparatus that can be used in, for example, a charging roller or a developing roller, a member for an image-forming apparatus having a substrate formed of a rubber or a resin and a metal coating on its surface, the metal coating being formed of a metal, a metal oxide, a metal carbide, a metal nitride, or a metal sulfide.

### SUMMARY OF THE INVENTION

The inventors of the present invention have conducted an investigation on a member for electrophotography having, on its surface, a coating formed of a metal oxide and having a thickness of 1,000 nm or less based on the disclosure of Japanese Patent Application Laid-Open No. 2009-037135. As a result, in such member for electrophotography, the coating has absorbed moisture under a high-humidity environment and hence the electrical resistance of the coating has excessively reduced in some cases. Accordingly, the use of such member for electrophotography as a developing roller has reduced charge-providing performance for toner in some cases. In addition, when a pinhole is present in a photosensitive member as a body to be charged, the use of such member for electrophotography as a charging roller has caused a current leak in the pinhole in some cases.

In view of the foregoing, the present invention is directed to providing a member for electrophotography whose electrical resistance does not largely change even under a high-humidity environment and whose performance as a charging member or a developing member shows only small environmental dependence. Further, the present invention is directed to providing a process cartridge and an electrophotographic apparatus capable of stably forming high-quality electrophotographic images even under various environments.

According to one aspect of the present invention, there is provided a member for electrophotography, including: a mandrel; an elastic layer; and a protective layer, in which the protective layer includes a zinc oxide film having a chemical bond represented by the following formula 1 and a chemical bond represented by the following formula 2.

Zn—O—R (Formula 1)

In the formula 1, R represents an alkyl group.

O—Zn—O (Formula 2)

According to another aspect of the present invention, there is provided a process cartridge, including the above-mentioned member for electrophotography, the process cartridge being attachable to and detachable from an electrophotographic apparatus. According to further aspect of the present invention, there is also provided an electrophotographic apparatus, including the above-mentioned member for electrophotography.

According to still further aspect of the present invention, there is also provided a member for electrophotography, including: a mandrel; an elastic layer; and a protective layer, in which the protective layer includes a zinc oxide film containing a composition represented by the following formula 3 and a composition represented by the following formula 4.

ZnO_{2/2} (Formula 3)

ZnO_{1/2}(OCₙH₂ₙ₊₁) (Formula 4)

In the formula 4, n represents an average number of carbon atoms in the composition represented by the formula 4 in the zinc oxide film and represents a real number of 1 or more and 4 or less.)

According to the present invention, a member for electrophotography having high charge-providing performance for toner even in a high-humidity environment can be obtained. In addition, according to the present invention, a process cartridge and an electrophotographic apparatus capable of forming high-quality electrophotographic images even under a high-humidity environment can be obtained.

Further features of the present invention will become apparent from the following description of exemplary embodiments with reference to the attached drawings.

### BRIEF DESCRIPTION OF THE DRAWINGS

FIG. 1A is a schematic sectional view of an example of a member for electrophotography of the present invention of a roller shape (conductive roller for electrophotography).

FIG. 1B is a schematic sectional view of the example of the member for electrophotography of the present invention of a roller shape (conductive roller for electrophotography).

FIG. 2 is a schematic view of an example of a CVD apparatus to be used in the formation of a protective layer.

FIG. 3 is a schematic view of an example of an image-forming portion in an electrophotographic apparatus of the present invention.

FIG. 4 is a schematic view of an example of the electrophotographic apparatus of the present invention.

### DESCRIPTION OF THE EMBODIMENTS

As described above, the use of a metal oxide in the protective layer is expected to improve the charge-providing performance of the member for electrophotography. However, the charge-providing performance has reduced in a high-humidity environment in some cases. This may be because of the following reason. That is, large polarization occurs between a metal atom having a small electronegativity and an oxygen atom having a large electronegativity, and hence polarization in a molecule of the metal oxide enlarges. Accordingly, a water molecule similarly having polarity is electrically attracted to the molecule of the metal oxide. As a result, the moisture absorption of the metal oxide, i.e., the protective layer under the high-humidity environment becomes significant and hence the charge-providing performance reduces.

In view of the foregoing, to suppress the phenomenon, the inventors of the present invention have decided to use a zinc atom having a relatively large electronegativity as the metal atom in the metal oxide constituting the protective layer and to introduce an alkyl group having electron-donating property so that the group may be adjacent to an oxygen atom bonded to the zinc atom. A difference in electronegativity between the zinc atom having a large electronegativity and the oxygen atom can be reduced as compared with a difference between any other metal atom and the oxygen atom, and hence the polarization in the molecule of the metal oxide can be suppressed.

The polarization in the molecule of the metal oxide can be similarly suppressed by introducing the alkyl group having electron-donating property so that the group may be adjacent to the oxygen atom having a large electronegativity. Accordingly, the member for electrophotography of the present invention having the protective layer can reduce the moisture absorption under the high-humidity environment while maintaining its high charge-providing performance.

In addition, the protective layer using the metal oxide tends to be hard and poor in flexibility. Accordingly, the use of the protective layer in a developing roller may result in poor followability of the protective layer to the elastic layer. It is because a bond between the metal atom and the oxygen atom is strong that the metal oxide tends to be hard and poor in flexibility.

In the meantime, the hardness of the zinc oxide film according to the present invention has been alleviated as compared with hardness which a general zinc oxide film has by bonding the alkyl group to the zinc atom in the molecule of the metal oxide through an oxygen atom to reduce the amount of a metal-oxygen bond having a strong bonding force. Further, the incorporation of the alkyl group can ameliorate the poor flexibility of the protective layer formed of an inorganic compound. Therefore, a member for electrophotography that hardly falls off the elastic layer even when used for a long time period and can stably maintain its high charge-providing performance is obtained.

<Member for Electrophotography>

The shape of the member for electrophotography according to the present invention can be appropriately selected from, for example, a roller shape and a belt shape, and the member can be used as a conductive roller such as a developing roller or a charging roller in, for example, an electrophotographic apparatus. Hereinafter, description is given while attention is paid to the conductive roller.

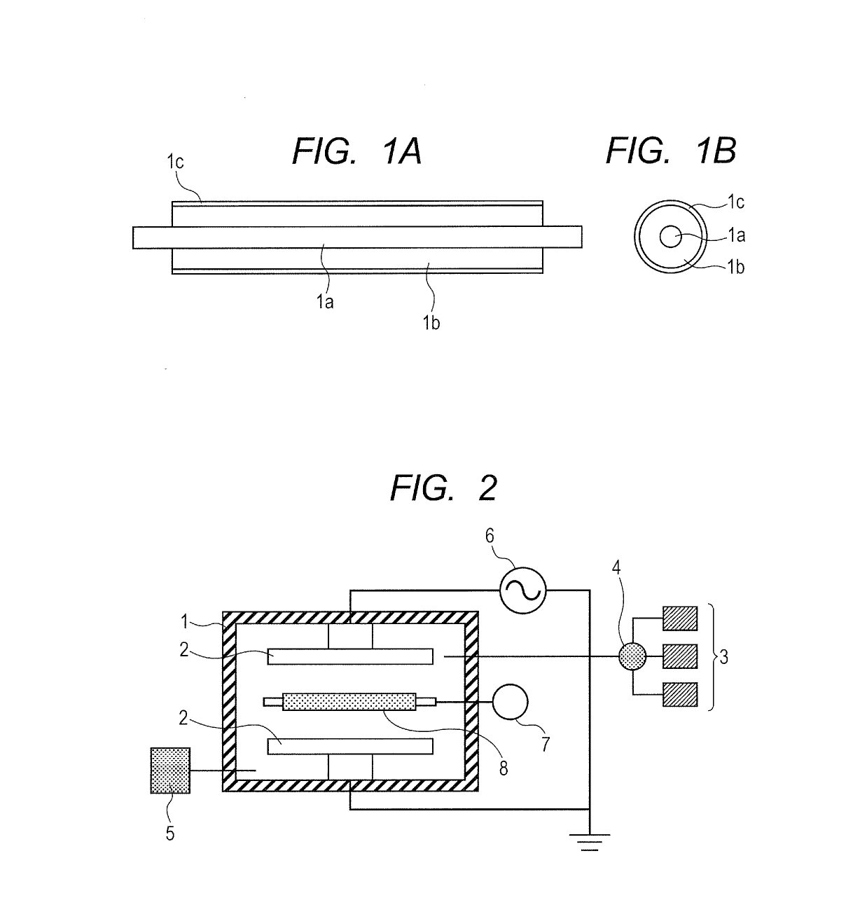

FIGS. 1A and 1B illustrate schematic sectional views of an example of the member for electrophotography of the present invention of a roller shape (conductive roller for electrophotography). FIG. 1A is a schematic sectional view upon cutting of the conductive roller in a direction parallel to the axial direction of a mandrel and FIG. 1B is a schematic sectional view upon cutting of the roller in a direction perpendicular thereto. The conductive roller has an elastic layer 1b on the outer periphery of a mandrel 1a and has a protective layer 1c on the outer periphery of the elastic layer 1b. The member for electrophotography of the present invention can have an adhesion layer (primer layer) or the like in addition to those layers.

(Mandrel)

A mandrel appropriately selected from mandrels each functioning as an electrode and supporting member for a conductive member can be used as the mandrel. A conductive material, e.g., a metal or an alloy such as aluminum, copper, stainless steel, or iron, or a conductive synthetic resin can be used as a material for the mandrel.

(Elastic Layer)

The elastic layer can be a layer for imparting elasticity to the member in order that the member may be in contact with a photosensitive member or a toner regulating member with a moderate area at the time of its press contact therewith. The elastic layer can be a single layer or multiple layers as long as the construction does not deviate from the purpose.

In addition, the elastic layer to be used in the present invention can be produced by using a material known in the field of a conductive roller to be used in an electrophotographic apparatus. For example, such a rubber as described below and a conductive agent for imparting conductivity to the elastic layer can be used as materials.

Examples of the rubber include an ethylene-propylene-diene copolymer rubber (EPDM), an acrylonitrile-butadiene rubber (NBR), a chloroprene rubber (CR), a natural rubber (NR), an isoprene rubber (IR), a styrene-butadiene rubber (SBR), a fluororubber, a silicone rubber, epichlorohydrin rubbers (e.g., an epichlorohydrin homopolymer (CO), an epichlorohydrin-ethylene oxide copolymer (ECO), and an epichlorohydrin-ethylene oxide-allyl glycidyl ether terpolymer (GECO)), a butadiene rubber (BR), a hydrogenated NBR, a polysulfide rubber, a urethane rubber, and a silicone rubber. Of those, there are particularly preferably used a silicon rubber whose hardness can be easily reduced and epichlorohydrin rubbers to each of which conductivity can be easily imparted by an ionic conductive agent that hardly increases the hardness of a rubber. Further, among the epichlorohydrin rubbers, from the viewpoint of production, an epichlorohydrin-ethylene oxide-allyl glycidyl ether terpolymer (GECO) which can be subject to sulfur vulcanization is particularly preferred. It is to be noted that, for the elastic layer, those rubbers may be used alone or as a mixture of several kinds thereof.

For example, carbon black can be used as the conductive agent to be blended into the elastic layer, and the carbon black can be used without any particular limitation. Examples thereof include acetylene black, and furnace blacks SAF, ISAF, HAF, MAF, FEF, GPF, and SRF. It is to be noted that the content of the carbon black in the elastic layer is preferably set to 1 mass % or more and 20 mass % or less with respect to the mass of the elastic layer from the viewpoint of conductivity, and the content more preferably falls within the range of 2 mass % or more and 18 mass % or less.

Further, in the elastic layer, any other conductive agent can be used in combination with the carbon black as required. Examples thereof include: various conductive metals or alloys such as graphite, aluminum, copper, tin, and stainless steel; and metal oxides obtained by subjecting tin oxide, zinc oxide, indium oxide, titanium oxide, a tin oxide-antimony oxide solid solution, and the like to various conducting treatments. It is to be noted that the content of any such other conductive agent in the elastic layer is preferably set to 2 mass % or more and 20 mass % or less with respect to the mass of the elastic layer from the viewpoint of conductivity, and the content more preferably falls within the range of 5 mass % or more and 18 mass % or less.

In addition, additives known in the field of the conductive roller for an electrophotographic apparatus can be used as other various additives. For example, a reinforcing agent such as hydrophilic silica, hydrophobic silica, quartz, calcium carbonate, aluminum oxide, zinc oxide, or titanium oxide may be added as required.

A method known in the field of the conductive roller for electrophotography can be employed as a production method of providing the elastic layer on the mandrel. For example, the following methods are given: a method involving co-extruding the mandrel and a material for forming the elastic layer to mold the layer, and when the material for forming the elastic layer is a liquid, a method involving injecting the material for forming the elastic layer into a mold, in which a cylindrical pipe, dies for holding the mandrel, the dies being placed at both ends of the pipe, and the mandrel are placed, and heating the material to cure the material.

It is to be noted that as described above, in the present invention, one or more elastic layers can be provided on the periphery of the mandrel. For example, the elastic layer of a stacked structure can be formed by providing, on the outer peripheral surface of an elastic layer as a first layer (first elastic layer) formed by using the rubber and the conductive agent, an elastic layer as a second layer (second elastic layer) for the purpose of, for example, providing the surface of the member for electrophotography with unevenness.

When a layer having a thickness of, for example, several micrometers to several millimeters is provided as the second elastic layer, the layer can be provided by using a material for forming the second elastic layer according to a production method known in the field of the conductive roller for electrophotography. The following resin materials (resin components) can be given as examples of the material for forming the second elastic layer. Specific examples thereof include a fluororesin, a polyamide resin, an acrylic urethane resin, a phenol resin, a melamine resin, a silicone resin, a urethane resin, a polyester resin, a polyvinyl acetal resin, an epoxy resin, a polyether resin, an amino resin, an acrylic resin, a urea resin, and a mixture thereof.

In addition, carbon black can be added to the material for forming the second elastic layer. The blending amount of the carbon black is preferably set to 3 parts by mass or more and 30 parts by mass or less with respect to 100 parts by mass of the rubber (resin) component from the viewpoint of conductivity.

Further, roughening particles for providing the surface of the conductive roller with unevenness can be added to those elastic layers. The roughening particles are not particularly limited, and resin particles such as acrylic resin particles, silicone resin particles, urethane resin particles, and phenol resin particles are preferred.

Available as the method of providing the second elastic layer having a thickness of several micrometers to several millimeters is, for example, a method involving coating the top of the first elastic layer with a coating liquid prepared by mixing and dispersing the rubber (resin) component, the carbon black, and a solvent to provide the layer.

Any solvent can be appropriately used as the solvent to be used in the coating liquid on condition that the rubber (resin) to be used in the second elastic layer is soluble in the solvent. Examples thereof include: ketones typified by methyl ethyl ketone (MEK) and methyl isobutyl ketone; hydrocarbons such as hexane and toluene; alcohols such as methanol and isopropanol; esters; and water. In consideration of the solubility of the rubber (resin) and the boiling point of the solvent, methyl ethyl ketone or methyl isobutyl ketone is particularly preferred as the solvent.

(Protective Layer)

The protective layer contains a zinc oxide film having a chemical bond (constitutional unit) represented by the following formula 1 and a chemical bond represented by the following formula 2. That is, the zinc oxide film has, for example, a structure represented by the following formula 5.

Zn—O—R] (Formula 1)

In the formula 1), R represents an alkyl group.

O—Zn—O (Formula 2)

O—Zn—O—Zn—O—R] (Formula 5)

In the formula 5, R represents an alkyl group.

It is to be noted that the total content of the chemical bond represented by the formula 1 and the chemical bond represented by the formula 2 in the protective layer is preferably 0.85 or more in terms of a molar fraction from the viewpoint of charge-providing performance for toner.

In addition, it can be said that the zinc oxide film according to the present invention is a film containing a chemical bond represented by the following formula 3 and a chemical bond represented by the following formula 4. It is to be noted that the chemical bond represented by the formula 1 is derived from a structure represented by the formula 4.

ZnO_{2/2} (Formula 3)

ZnO_{1/2}(OCₙH₂ₙ₊₁) (Formula 4)

In the formula 4, n represents an average number of carbon atoms in the structure represented by the formula 4 in the zinc oxide film and represents a real number of 1 or more. That is, the zinc oxide film according to the present invention can contain one or two or more kinds of chemical bonds represented by the formula 1. Here, when the zinc oxide film contains only one kind of chemical bond represented by the formula 1, n in the formula 4 determined from the analysis of the zinc oxide film represents the same value (number) as the number of carbon atoms of the alkyl group in the one kind of chemical bond represented by the formula 1. For example, when the zinc oxide film has only —Zn—O—CH₃ as a chemical bond satisfying the formula 1, n in the formula 4 represents 1.

On the other hand, when the zinc oxide film contains multiple kinds of chemical bonds represented by the formula 1, n in the formula 4 determined from the analysis represents the average number of carbon atoms of the alkyl groups in the chemical bonds. For example, when the zinc oxide film contains —Zn—O—CH₃ and —Zn—O—C₂H₅ in equal amounts (1:1) in terms of a molar ratio as chemical bonds represented by the formula 1, n in the formula 4 represents 1.5. That is, the zinc oxide film has the composition of ZnO_{1/2}(OC_{1.5}H₄).

It is to be noted that the total content of the respective compositions represented by the formula 3 and formula 4 in the protective layer is preferably 0.85 or more in terms of a molar fraction from the viewpoint of charge-providing performance for toner.

The member for electrophotography according to the present invention has a protective layer formed of a zinc oxide film having a chemical bond represented by the formula 1 and a chemical bond represented by the formula 2, and hence can realize stably high charge-providing performance even under various environments. In addition, the protective layer has the chemical bond represented by the formula 1 unlike a conventional zinc oxide film having only a chemical bond represented by the formula 2 or formula 3. That is, the zinc oxide film has the chemical bond represented by the formula 1 or formula 4 in which a carbon atom derived from an alkyl group having electron-donating property is bonded to at least part of the zinc atoms constituting the film through an oxygen atom. Accordingly, the polarization in the zinc oxide film can be suppressed as compared with the conventional one. As a result, the moisture absorption of the member for electrophotography under a high-humidity environment and the reduction of its charge-providing performance in association therewith can be suppressed. Accordingly, when the member for electrophotography according to the present invention is used as a developing roller, the roller exerts high charge-providing performance for toner even in the high-humidity environment. In addition, when the member for electrophotography according to the present invention is used as a charging roller, the occurrence of a pinhole leak phenomenon can be suppressed even under the high-humidity environment.

In addition, the zinc oxide film according to the present invention has higher flexibility than that of a general metal oxide film. Therefore, the member for electrophotography of the present invention hardly peels off the elastic layer even after its long-term use. In this respect as well, the member for electrophotography according to the present invention is excellent in durability.

It is to be noted that the alkyl group (R) in the formula 1 preferably has 1 or more and 4 or less carbon atoms. Setting the number of carbon atoms of the alkyl group (R) in the formula 1 to 4 or less facilitates the handling of a raw material and enables the formation of a film having stable quality. It is to be noted that when the alkyl group (R) in the formula 1 has 1 or more and 4 or less carbon atoms, n in the formula 4 represents a real number of 1 or more and 4 or less.

(Method of Producing Protective Layer)

A method of producing the protective layer according to the present invention is, for example, a physical vapor deposition (PVD) method such as vacuum vapor deposition, sputtering, or ion plating, a chemical vapor deposition (CVD) method such as plasma CVD, thermal CVD, or laser CVD, or a sol-gel method. In addition, the plasma CVD method and the sol-gel method are preferred from the viewpoint of processability.

Plasma CVD Method

When an alkoxy group-containing zinc oxide film is produced by the plasma CVD method, the film can be formed with, for example, an apparatus illustrated in FIG. 2. The apparatus is constituted of: a vacuum chamber 1; two plate electrodes 2 placed so as to be parallel to each other; raw material gas bombs and raw material liquid tanks 3; raw material-supplying means 4; means 5 for exhausting a gas in the chamber; a high-frequency power-supplying power source for supplying high-frequency power; and a motor 7 for rotating an elastic roller 8.

Further, the alkoxy group-containing zinc oxide film can be produced with the apparatus of FIG. 2 by the following procedures.

Procedure (1) The elastic roller 8 in which an elastic layer is formed on a mandrel is placed between the two plate electrodes 2, and then the motor 7 is driven to rotate the roller in its circumferential direction about the axis of the mandrel so that the alkoxy group-containing zinc oxide film may be uniformly formed.
Procedure (2) The inside of the vacuum chamber 1 is evacuated to 1 Pa or less by the exhausting means 5.
Procedure (3) A raw material gas is introduced from a raw material gas-introducing port and then it is confirmed that the pressure in the vacuum chamber 1 becomes constant. After that, film formation is performed by generating plasma through the supply of high-frequency power to the plate electrodes 2 by the high-frequency power-supplying power source 6.
Procedure (4) After a lapse of a predetermined time period, the supply of the raw material gas and the high-frequency power is stopped. Air or nitrogen is introduced (leaked) into the vacuum chamber 1 until the pressure reaches atmospheric pressure, and then the elastic roller having the alkoxy group-containing zinc oxide film formed on its surface is taken out.

A conductive roller having the alkoxy group-containing zinc oxide film can be produced by such procedures as described above. It is to be noted that a large number of the elastic rollers 8 to be subjected to a plasma CVD treatment may be simultaneously treated as long as the rollers can be placed under a uniform plasma atmosphere.

It is to be noted that an alkylzinc or alkoxyzinc that is gaseous or gasified is typically introduced as the raw material gas together with oxygen, and an inert gas such as argon or helium is introduced together as required. Dimethylzinc and diethylzinc can be given as examples of the alkylzinc to be used in the raw material gas, and an alkylzinc an alkyl group of which has 1 or more and 4 or less carbon atoms is preferably used from the viewpoint of gasification. In addition, diisopropoxyzinc and di-tert-butoxyzinc can be given as examples of the alkoxyzinc, and an alkoxyzinc an alkoxy group of which has 1 or more and 4 or less carbon atoms is preferably used from the viewpoint of gasification. In addition, one kind of those materials may be used alone, or a mixture of multiple kinds thereof may be used.

Further, one or more alkylmetals or alkoxymetals whose metal moieties are metals except zinc can be used as a mixture with the alkylzinc or the alkoxyzinc. Thus, the alkyl group (R) in the formula 1 can be introduced into a zinc oxide structure. At this time, one kind of alkylzincs or alkoxyzincs may be used alone, or multiple kinds thereof may be used as a mixture. It is to be noted that examples of the alkylmetals or alkoxymetals whose metal moieties are metals except zinc include tetramethylsilane, tetraethoxytitanium, and tetraisopropoxytitanium. As can be understood from the foregoing, the protective layer to be used in the present invention can be a plasma CVD film using at least one

Sol-Gel Method

When the alkoxy group-containing zinc oxide film is produced by the sol-gel method, the film can be produced by, for example, the following method. That is, a hydrolyzable alkoxyzinc is added to a mixed solvent of an alcohol and water. A mixing ratio between the alcohol and water can be freely set to such an extent that the alkoxyzinc is soluble in the mixed solvent. In addition, any alcohol can be arbitrarily used as the alcohol as long as the alcohol is water-soluble. It is to be noted that an alkoxyzinc represented by the following formula 6 is preferably used from the viewpoint of reactivity. In addition, one kind of alkoxyzincs can be used alone, or two or more kinds thereof can be used as a mixture.

Zn(OR_{Y})₂ (Formula 6)

In the formula 6, R_{Y} represents an alkyl group having 1 or more and 4 or less carbon atoms. Here, when R_{Y} represents an alkyl group having 1 or more and 4 or less carbon atoms, a reduction in reactivity due to steric hindrance is suppressed and hence the production of the zinc oxide film by the sol-gel method can be easily performed.

After that, the mixture is diluted with a solvent such as methyl ethyl ketone or ethyl acetate as required for viscosity adjustment or an improvement in application property, and then the diluted liquid is applied onto the peripheral surface of the elastic roller provided with the elastic layer, followed by heating. Thus, the alkoxy group-containing zinc oxide film (protective layer) can be formed. That is, the protective layer can contain a hydrolysis condensate of the alkoxyzinc, or can be formed of the hydrolysis condensate of the alkoxyzinc.

It is to be noted that from the viewpoint of suppressing the reaction of all alkoxy groups in a film molecule due to the progress of the hydrolysis and condensation during the heating, the groups are preferably subjected to a reaction at a low heating temperature, specifically, 130° C. or more and 160° C. or less. In addition, a time for the heating is preferably set to 1 hour or more and 2 hours or less.

(Method of Measuring Protective Layer)

That the protective layer of the member for electrophotography of the present invention has the respective compositions represented by the formula 3 and formula 4, and the respective chemical bonds represented by the formula 1, formula 2, and formula 5 can be confirmed with a scanning X-ray electron spectrometer.

It is to be noted that the average number n of carbon atoms of the alkyl groups in the formula 4 is preferably 2.0 or more and 3.0 or less from the viewpoint of compatibility between flexibility and abrasion resistance. Setting the average number n of carbon atoms of the alkyl groups within the range can suppress a reduction in flexibility of the protective layer and a reduction in abrasion resistance thereof. It is to be noted that the average number n of carbon atoms of the alkyl groups can be identified by analysis with a scanning X-ray photoelectron spectrometer.

Further, an abundance ratio (formula 3/formula 4) between the structure represented by the formula 3 and the structure represented by the formula 4 in the protective layer is preferably 0.33 or more and 3.1 or less from the viewpoint of compatibility between charge-providing performance and hygroscopic property. Setting the abundance ratio within the numerical range can establish a balance between the ratio of the chemical bond represented by the formula 2 in the protective layer which contributes to an improvement in charge-providing performance and the ratio of the chemical bond represented by the formula 1 therein which contributes to the suppression of moisture absorption. As a result, a member for electrophotography whose basic charge-providing performance has been highly improved and whose performance variation due to moisture absorption has been suppressed can be obtained. The abundance ratio between the formula 3 and the formula 4 can also be identified with the scanning X-ray photoelectron spectrometer.

It is to be noted that a PHI5000 VersaProbe (trade name; manufactured by ULVAC-PHI, Inc.) can be used as the scanning X-ray photoelectron spectrometer to be used in the measurement of the protective layer. The average number of carbon atoms of the alkyl groups in the formula 4 can be determined by measuring the amount of a carbon atom to which a carbon atom is bonded (C_{C—C}) and the amount of an oxygen atom to which a carbon atom is bonded (O_{C—O}). In addition, the abundance ratio between the compositions represented by the formula 3 and formula 4 can be determined by measuring the amount of oxygen atoms and the amount of an oxygen atom to which a carbon atom is bonded (O_{C—O}) in the protective layer.

In addition, as a guideline, the thickness of the protective layer is preferably 100 nm or more and 1,000 nm or less. A thin film-measuring apparatus (trade name: F20-EXR; manufactured by FILMETRICS) can be used in the measurement of the thickness. Specifically, the conductive roller is divided into three equal portions in its longitudinal direction and is divided into three equal portions in its circumferential direction. The measurement is performed at one site for each of the portions, i.e., at a total of nine sites, and the average of the resultant values can be regarded as the thickness.

<Electrophotographic Apparatus>

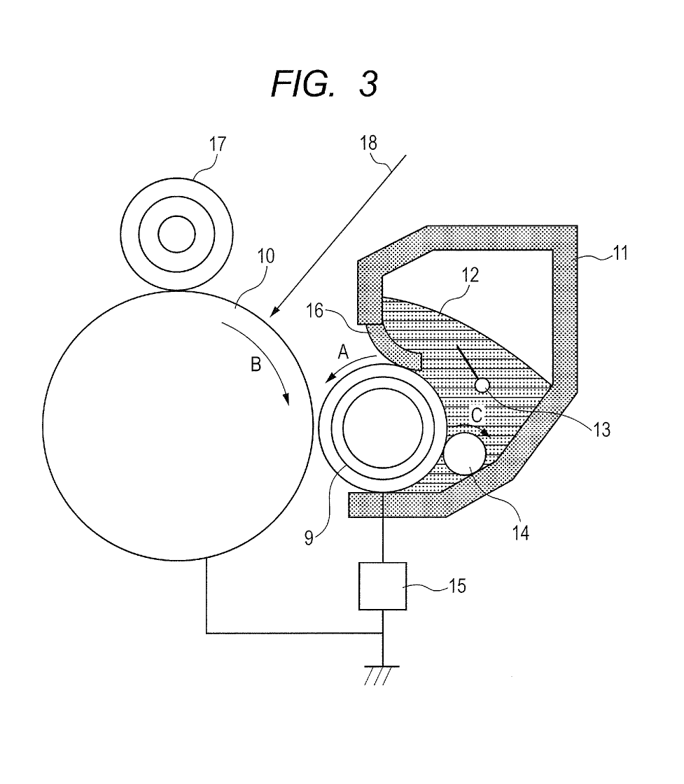

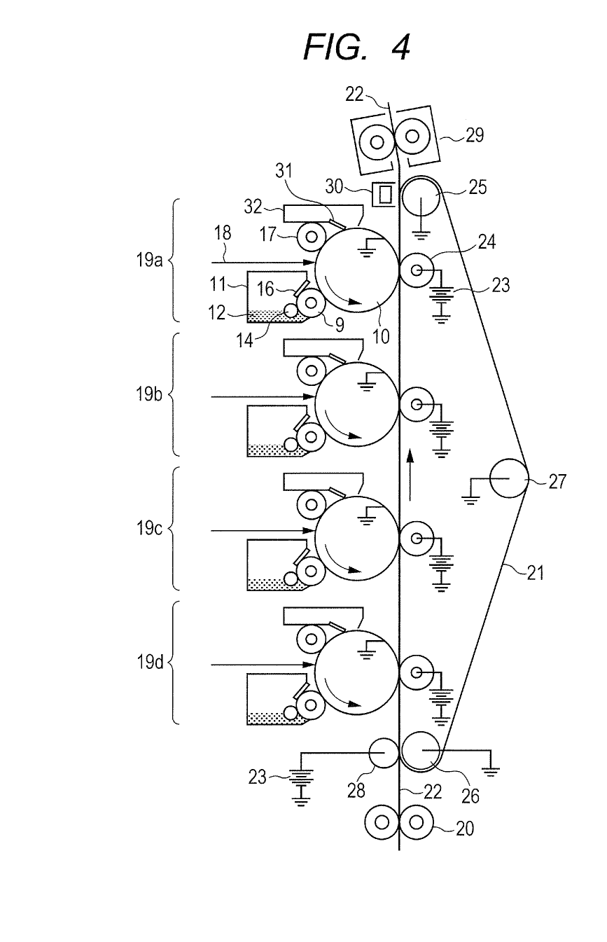

FIG. 4 illustrates an example of an electrophotographic apparatus in which the member for electrophotography of the present invention can be used. The apparatus can have, for example, an image-forming portion illustrated in FIG. 3, and the member for electrophotography of the present invention can be used as a developing roller 9 or a charging roller 17. Hereinafter, the image-forming portion and the electrophotographic apparatus are described in detail.

First, the image-forming portion illustrated in FIG. 3 is described. The developing roller 9 that rotates in a direction indicated by an arrow A and a photosensitive member 10 that rotates in a direction indicated by an arrow B are placed in the image-forming portion in a state where the roller and the member are opposite to each other (both the roller and the member may be in contact with each other). A stirring blade 13 for stirring a non-magnetic toner 12 is provided in a hopper 11 as a toner container. In addition, the non-magnetic toner 12 is supplied onto the developing roller 9 by a toner-supplying/stripping member 14 that rotates in a direction indicated by an arrow C, and a development residual toner that has not been used in development on the photosensitive member 10 is recovered from the top of the developing roller 9 by the toner-supplying/stripping member 14. Thus, the charging of the toner on the developing roller 9 is uniformized. It is to be noted that the toner-supplying/stripping member 14 is preferably a roller member having elasticity, the roller being made of, for example, a resin, a rubber, or a sponge. In addition, a voltage is applied to the developing roller by a developing bias power source 15 and the photosensitive member 10 is charged by the charging roller 17. Further, an electrostatic latent image is formed on the photosensitive member 10 by laser light 18 applied from exposing means (not shown). Through the foregoing process, the electrostatic latent image on the photosensitive member 10 is developed with the toner 12, which has been charged by its friction with the developing roller 9, by an electric field formed between the developing roller 9 and the photosensitive member 10. It is to be noted that as a toner regulating member 16 for controlling the layer thickness of the toner 12 on the developing roller 9, there can be used the toner regulating member 16 made of a material having rubber elasticity such as a urethane rubber or a silicone rubber, or a material having metal elasticity such as phosphor bronze or stainless copper. Bringing the toner regulating member 16 into press contact with the developing roller 9 can result in the formation of an additionally thin toner layer on the developing roller 9.

Next, the electrophotographic apparatus illustrated in FIG. 4 is described. The electrophotographic apparatus has image-forming portions (for respective colors) (19a to 19d) provided for the yellow (Y), magenta (M), cyan (C), and black (K) toner colors, respectively in tandem. Although the specifications of the image-forming portions slightly differ from one another according to the characteristics of the respective color toners, the image-forming portions are identical to one another in basic construction and the construction is as illustrated in FIG. 3. A toner image formed on the photosensitive member 10 is transferred onto a recording medium (transfer material) 22 such as paper fed by a sheet-feeding roller 20 and conveyed by a conveying belt 21. It is to be noted that at the time of the transfer onto the recording medium, a voltage is applied by a transfer roller 24, to which a voltage has been applied by a power source 23, to the recording medium from the back side of its transfer surface. The conveying belt 21 is suspended over a driving roller 25, a coupled driving roller 26, and a tension roller 27, and is controlled to convey the recording medium 22 in sync with each image-forming portion so that toner images formed in the respective image-forming portions can be sequentially transferred onto the recording medium 22 in a superimposing manner. It is to be noted that the recording medium 22 is adapted to be electrostatically adsorbed to the conveying belt 21 by the action of an adsorbing roller 28, which is provided immediately before the medium approaches the conveying belt 21, and then conveyed. Further, the electrophotographic apparatus is provided with: a fixing device 29 for fixing the toner images transferred onto the recoding medium 22 in a superimposing manner through heating or the like; and a conveying apparatus (not shown) for discharging the recording medium onto which the images have been formed to the outside of the apparatus. It is to be noted that the recording medium 22 is adapted to be peeled from the conveying belt 21 by the action of a peeling device 30 and then conveyed to the fixing device 29. Meanwhile, the transfer residual toner remaining on the photosensitive member 10 without being transferred is removed by a cleaning member having a cleaning blade 31 and then the toner that has been scraped off the photosensitive member is recovered in a waste toner container 32. The photosensitive member 10 cleaned through the foregoing process is brought into a state of being capable of forming an image again.

In addition, a process cartridge of the present invention includes at least the member for electrophotography of the present invention. Specifically, the process cartridge can include the image-forming portion illustrated in FIG. 3 and a cleaning member. The process cartridge is obtained by integrally holding those members and is attachable to and detachable from an image-forming apparatus (electrophotographic apparatus).

<Developing Roller>

### Example 1

### Production of Conductive Roller for Electrophotography

Production of Elastic Roller

A rubber mixture layer obtained by sufficiently kneading materials shown in Table 1 below was provided on the mandrel 1a made of stainless steel with a crosshead extruder, and was then heated at 140° C. for 60 minutes. Thus, an elastic roller having an elastic layer 1b-A around the mandrel was produced. It is to be noted that the mandrel 1a had a diameter of 6 mm and a length in its axial direction of 279 mm, the thickness of the elastic layer was 3 mm, and the length of the elastic layer in the axial direction of the mandrel was 242 mm.

TABLE 1

| | Part(s) |
|---|---|
| Material | by mass |
| Epichlorohydrin-ethylene oxide-allyl glycidyl ether | 100 |
| terpolymer (trade name: EPICHLOMER CG; manufactured | |
| by DAISO CO., LTD.) | |
| Stearic acid (trade name: stearic acid S; | 2 |
| manufactured by Kao Corporation) | |
| Calcium carbonate (trade name: NANOX #30; | 44 |
| manufactured by Maruo Calcium Co., Ltd.) | |
| Carbon black (trade name: TOKABLACK #7360SB; | 5 |
| manufactured by TOKAI CARBON CO., LTD.) | |
| Sulfur (trade name: Sulfax 200S; manufactured by | 1.2 |
| TSURUMI CHEMICAL INDUSTRY CO., LTD.) | |
| Di-2-benzothiazolyl tetrasulfide (trade name: | 1.0 |
| NOCCELER DM; manufactured by OUCHI SHINKO | |
| CHEMICAL INDUSTRIAL CO., LTD.) | |
| Dipentamethylenethiuram tetrasulfide (trade name: | 1.0 |
| NOCCELER TRA; manufactured by OUCHI SHINKO | |
| CHEMICAL INDUSTRIAL CO., LTD.) | |
| Zinc oxide (trade name: zinc oxide type 2; | 5.0 |
| manufactured by HakusuiTech Co., Ltd.) | |

Production of Protective Layer 1c

(Protective Layer Production Method 1: Method of Producing Alkoxy Group-Containing Zinc Oxide Film with CVD Apparatus)

The resultant elastic roller was set in the CVD apparatus illustrated in FIG. 2 and then the pressure in the vacuum chamber was reduced to 1 Pa with a vacuum pump. While the elastic roller set in the CVD apparatus was rotated at 20 rpm (min⁻¹), gasified dimethylzinc was introduced into the vacuum chamber at a flow rate of 5.0 sccm and oxygen was introduced thereinto at a flow rate (X) of 7.0 sccm through a pressure reduction and heating. It is to be noted that the unit “sccm” means a flow rate (cm³) per minute at 1 atm (1,013 hPa) and 23° C. While those raw material gases were introduced, a 70-W power having a frequency of 13.6 MHz was supplied to the plate electrodes by the high-frequency power source to generate plasma between the electrodes. The protective layer 1c was formed on the peripheral surface of the elastic roller by maintaining the state for a time (Y) of 120 seconds. Thus, a conductive roller was produced. It is to be noted that the thickness of the protective layer was measured with a thin film-measuring apparatus (trade name: F20-EXR; manufactured by FILMETRICS) by the method described above. As a result, the thickness was 250 nm. The resultant conductive roller was subjected to the following evaluations. It is to be noted that evaluations paying attention to the structures represented by the formula 3 and formula 4 in the protective layer were performed here.

(Evaluation A)

Evaluation for average number of carbon atoms of alkyl groups in formula 4, and abundance ratio (formula 3/formula 4) between structures represented by formula 3 and formula 4

The protective layer 1c of the produced conductive roller was measured for the amount of a carbon atom to which a carbon atom was bonded (C_{C—C}) and the amount of an oxygen atom to which a carbon atom was bonded (O_{C—O}), and then the average number n of carbon atoms of the alkyl groups (CₙH₂ₙ₊₁) in the formula 4 was determined from these ratios. Then, the alkyl group (R) in the chemical bond represented by the formula 1 in the protective layer was inferred from the value for the average number n of carbon atoms. In addition, a ratio between the structure represented by the formula 3 and the structure represented by the formula 4 was determined by measuring the amount of oxygen and the amount of an oxygen atom to which a carbon atom was bonded (O_{C—O}) in the protective layer 1c. A scanning X-ray photoelectron spectrometer (trade name: PHI5000 VersaProbe; manufactured by ULVAC-PHI, Inc.) was used in those measurements.

Total content of respective compositions represented by formula 3 and formula 4 in protective layer

The total content of the structure represented by the formula 3 and the structure represented by the formula 4 in the protective layer was measured with a scanning X-ray photoelectron spectrometer (trade name: PHI5000 VersaProbe; manufactured by ULVAC-PHI, Inc.).

(Evaluation B)

Image Evaluation of Developing Roller

The produced conductive roller was incorporated as a developing roller into the cartridge for magenta of a color laser printer: LBP7700C (trade name; manufactured by Canon Inc.). After that, under each of the following environments, such an image that an alphabetical letter “E” having a size of 4 points was printed at a percentage of 1% (hereinafter, referred to as “E-letter image”) was output on 1 sheet of A4 size paper. Subsequently, image formation was stopped in the midst of the output of 1 white solid image, the developing roller was taken out of the image-forming apparatus, and the charge quantity of toner on the developing roller was measured. A toner charge quantity distribution-measuring apparatus (E-SPART Analyzer MODELEST-III ver. 03 (trade name); manufactured by Hosokawa Micron Corporation) was used in the measurement of the charge quantity distribution of the toner.

Next, the developing roller was mounted on the image-forming apparatus to output 1 solid white image. The solid white image is referred to as “solid white image 1.” Next, 14,999 E-letter images were output again. Subsequently, image formation was stopped in the midst of the output of 1 solid white image, the developing roller was taken out of the image-forming apparatus, and the charge quantity of the toner on the surface of the developing roller was measured in the same manner as in the foregoing. Next, the developing roller was mounted on the image-forming apparatus again, followed by the output of 1 solid white image. The solid white image is referred to as “solid white image 2”.

(Environment 1) Temperature 20° C./relative humidity 70%
(Environment 2) Temperature 20° C./relative humidity 10%

(1) Fogging Performance Evaluation

(1-1) Calculation of Ratio of Positive Toner

A ratio r_{A} of a positive toner to all toners under the environment 1 and a ratio r_{B} of a positive toner to all toners under the environment 2 were determined. Then, a ratio r_{A}/r_{B} after the output of the first E-letter image was defined as R₁, a ratio r_{A}/r_{B} after the output of the 15,000th E-letter image was defined as R_{15,000}, and the developing roller after the output of the first E-letter image and that after the output of the 15,000th E-letter image were evaluated by the following criteria based on the numerical ranges of the R₁ and the R_{15,000}. It is to be noted that the term “positive toner” means a toner having a charge quantity of zero or a positive charge quantity (that is, having a charge quantity of 0 or more). A reduction in charge-providing performance of the developing roller for toner increases the ratio of the positive toner, thereby increasing fogging.

A rank: 1.0 or more and 1.5 or less
B rank: 1.7 or more and 2.0 or less
C rank: 2.2 or more

(1-2) Evaluation with White Photometer

The reflection densities of the solid white image 1 and the solid white image 2 output under the environment 1 were measured with a white photometer TC-60DS/A (trade name; manufactured by Tokyo Denshoku CO., LTD.). Then, a density difference when the printed portion and non-printed portion of each of the solid white images were subjected to the measurement was evaluated as fogging (%). The fogging of the solid white image 1 was represented by P₁ (%), the fogging of the solid white image 2 was represented by P_{15,000} (%), and each fogging was evaluated as described below.

A rank: 1.0% or less
B rank: 1.5% or more and 3.0% or less
C rank: 3.5% or more

(2) Evaluation of Developing Roller for its Durability

The surface of the developing roller taken out of the color laser printer after the output of 15,004 images under each of the environment 1 and the environment 2, i.e., after the printing of the solid white image 2 was subjected to air blowing for 30 seconds. After that, the surfaces of those developing rollers were observed with an optical microscope (trade name: VK-9700; manufactured by KEYENCE CORPORATION) and then the rollers were each evaluated based on the following criteria.

A: Chipping or falling is not observed.
B: Chipping or falling is partially observed.
C: Chipping or falling is observed in the entire surface.

Table 5 shows conditions for the production of the conductive roller produced in Example 1, and the results of the analyses of the protective layer by (Evaluation A). In addition, Table 6 shows the results of the evaluations of the roller as a developing roller by (Evaluation B).

### Examples 2 and 3

Conductive rollers were produced by the same method as that of Example 1 except that the elastic layer 1b-A which the elastic roller had was changed to an elastic layer 1b-B and an elastic layer 1b-C formed of two elastic layers described below, respectively. It is to be noted that Table 5 shows their production conditions and the results of the analyses of their protective layers, and Table 6 shows the results of the evaluations of the rollers as developing rollers.

(Production of Elastic Roller Having Elastic Layer 1b-B)

A rubber mixture layer obtained by sufficiently kneading materials shown in Table 2 below was provided on the mandrel 1a made of stainless steel used in Example 1 with a crosshead extruder, and was then heated at 170° C. for minutes. Thus, an elastic roller having the elastic layer 1b-B having the same thickness and length as those of Example 1 was produced.

TABLE 2

| | Parts by |
|---|---|
| Material | mass |
| Silicone rubber (trade name: TSE270-5U; | 90 |
| manufactured by Momentive Performance Materials | |
| Japan LLC) | |
| Crosslinking agent (trade name: TC-8; | 8 |
| manufactured by Momentive Performance Materials | |
| Japan LLC) | |
| Carbon black (trade name: DENKA BLACK; | 12 |
| manufactured by DENKI KAGAKU KOGYO KABUSHIKI | |
| KAISHA) | |
| Zinc oxide (trade name: zinc oxide type 2; | 5.0 |
| manufactured by HakusuiTech Co., Ltd.) | |

(Production of Elastic Roller Having Elastic Layer 1b-C (Multiple Elastic Layers))

A cylindrical pipe having an inner diameter of 12 mm, dies at both of its ends for fixing the mandrel 1a, and the mandrel 1a used in Example 1 were assembled. A liquid material for forming an elastic layer prepared by dispersing materials shown in Table 3 below was injected from the die at one end, and was then heated at 150° C. for 20 minutes. After having been cooled, the resultant was removed from the mold and then heated in an oven at 200° C. for 5 hours. Thus, a first elastic layer was provided on the periphery of the mandrel 1a.

TABLE 3

| | Parts by |
|---|---|
| Material constituting first elastic layer | mass |
| Silicone rubber (trade name: XE15-645A liquid; manufactured | 50 |
| by Momentive Performance Materials Japan LLC) | |
| Silicone rubber (trade name: XE15-645B liquid; manufactured | 50 |
| by Momentive Performance Materials Japan LLC) | |
| Carbon black (trade name: HS-100; manufactured | 12 |
| by DENKI KAGAKU KOGYO KABUSHIKI KAISHA) | |
| Zinc oxide (trade name: zinc oxide type 2; | 5.0 |
| manufactured by HakusuiTech Co., Ltd.) | |

Next, materials shown in Table 4 below were weighed. MEK was added to the materials and then the contents were sufficiently mixed. The mixture was charged into an overflow-type circulating application apparatus. An elastic roller provided with the first elastic layer was immersed in the application apparatus and then pulled up, followed by heating at 150° C. for 5 hours. Thus, a second elastic layer as a rubber (resin) layer having a thickness of about 10 μm was provided on the peripheral surface of the first elastic layer.

TABLE 4

| | Parts by |
|---|---|
| Material constituting second elastic layer | mass |
| Polyol (trade name: N5120; manufactured by | 85 |
| Nippon Polyurethane Industry Co., Ltd.) | |
| Isocyanate (trade name: L-55E; manufactured by | 11 |
| Nippon Polyurethane Industry Co., Ltd.) | |
| Carbon black (trade name: MA77; manufactured by | 35 |
| Mitsubishi Chemical Corporation) | |
| Acrylic particles (trade name: C-400 | 8 |
| TRANSPARENT; manufactured by Negami Chemical | |
| Industrial Co., Ltd.) | |

Thus, an elastic roller having the elastic layer 1b-C formed of two elastic layers was obtained. It is to be noted that the total thickness of the elastic layer 1b-C was 3 mm and its length in the axial direction of the roller was 242 mm.

### Examples 4 to 10

Conductive rollers were each produced by the same method as that of Example 1 except that the kind of the elastic layer and the conditions for the production of the protective layer were changed to conditions shown in Table 5. It is to be noted that Table 5 shows the results of the analyses of the protective layers and Table 6 shows the results of the evaluations of the rollers as developing rollers.

It is to be noted that raw materials A to S in the CVD production conditions shown in Tables 5, 7, and 13 represent the following respective compounds. Mixing ratios in the raw materials E to S are substance amount ratios.

A: dimethylzinc
B: diethylzinc
C: diisopropoxyzinc
D: di-tert-butoxyzinc
E: mixture of A/B=1/1
F: mixture of A/C=1/1
G: mixture of A/D=1/1
H: mixture of B/C=1/1
I: mixture of B/D=1/1
J: mixture of C/D=1/1
K: mixture of A/B/C=1/1/1
L: mixture of A/B/D=1/1/1
M: mixture of A/C/D=1/1/1
N: mixture of B/C/D=1/1/1
O: mixture of A/B/C/D=1/1/1/1
P: mixture of A/D=3/1
Q: mixture of A/D=1/5
R: mixture of A/D=1/15
S: mixture of B/tetramethylsilane=5/1

TABLE 5

| | | | | | | Average number n | | | |
|---|---|---|---|---|---|---|---|---|---|
| | | CVD production | | | | of carbon atoms | | formula | Total content of |
| | | conditions | | | Thickness of | of alkyl groups in | | 3/formula 4 | formulae 3 and 4 |
| | Elastic | Raw | X | Y | protective layer | formula 4 | Inferred R | (analytical | in protective layer |
| Example | layer | material | (sccm) | (sec) | (nm) | (analytical value) | in formula 1 | value) | (molar fraction) |
| 1 | 1b-A | A | 7.0 | 120 | 250 | 1.0 | CH₃ | 2.1 | 0.97 |
| 2 | 1b-B | A | 7.0 | 120 | 250 | 1.0 | CH₃ | 2.1 | 0.96 |
| 3 | 1b-C | A | 7.0 | 120 | 250 | 1.0 | CH₃ | 2.1 | 0.98 |
| 4 | 1b-A | B | 7.0 | 120 | 250 | 2.0 | C₂H₅ | 2.2 | 0.95 |
| 5 | 1b-B | B | 7.0 | 120 | 250 | 2.0 | C₂H₅ | 2.2 | 0.97 |
| 6 | 1b-C | B | 7.0 | 120 | 250 | 2.0 | C₂H₅ | 2.2 | 0.98 |
| 7 | 1b-B | C | 2.2 | 120 | 250 | 3.0 | C₃H₇ | 2.3 | 0.99 |
| 8 | 1b-C | C | 2.2 | 120 | 250 | 3.0 | C₃H₇ | 2.3 | 0.97 |
| 9 | 1b-B | D | 2.2 | 120 | 250 | 4.0 | C₄H₉ | 2.3 | 0.95 |
| 10 | 1b-C | D | 2.2 | 120 | 250 | 4.0 | C₄H₉ | 2.3 | 0.98 |

TABLE 6

| | Fogging evaluation | | | | Durability evaluation | |
|---|---|---|---|---|---|---|
| Example | R₁ | P₁ | R_{15,000} | P_{15,000} | Environment 1 | Environment 2 |
| 1 | A | A | B | B | B | B |
| 2 | A | A | B | B | B | B |
| 3 | A | A | B | B | B | B |
| 4 | A | A | A | A | A | A |
| 5 | A | A | A | A | A | A |
| 6 | A | A | A | A | A | A |
| 7 | A | A | A | A | A | A |
| 8 | A | A | A | A | A | A |
| 9 | A | A | B | B | B | B |
| 10 | A | A | B | B | B | B |

In each of Examples 1 to 10, the protective layer of the conductive roller is constituted of a zinc oxide film having the chemical bond represented by the formula 1 and the chemical bond represented by the formula 2, and containing the structure represented by the formula 3 and the structure represented by the formula 4.

As is apparent from Table 6, the use of the conductive roller as a developing roller was able to suppress fogging and showed no conspicuous chipping or falling of the protective layer. In particular, in the cases of Examples 4 to 8 in each of which the average number of carbon atoms of the alkyl groups in the composition represented by the formula 4 in the protective layer 1c was 2.0 or more and 3.0 or less, excellent results of the evaluations were obtained. This may be because when the analytical value for the average number of carbon atoms of the alkyl groups in the formula 4 is 2.0 or more and 3.0 or less, compatibility between the abrasion resistance and flexibility of the protective layer can be easily attained. In addition, the total content of the respective compositions represented by the formula 3 and formula 4 in the protective layer of each of Examples 1 to 10 was 0.95 to 0.99 (molar fraction). It is to be noted that structures except the chemical bond represented by the formula 1 and the chemical bond represented by the formula 2 which the protective layer produced in each example has are, for example, chemical bonds represented by the following formula 7 and formula 8.

Zn—Zn—Zn (Formula 7)

CH₂—O—CH₂ (Formula 8)

### Examples 11 to 21

Conductive rollers were each produced by the same method as that of Example 1 except that the kind of the elastic layer and the conditions for the production of the protective layer were changed as shown in Table 7. It is to be noted that Table 7 shows the results of the analyses of the protective layers and Table 8 shows the results of the evaluations of the rollers as developing rollers.

TABLE 7

| | | | | | | Average number | | | |
|---|---|---|---|---|---|---|---|---|---|
| | | CVD | | | Thickness | n of carbon | | | Total content |
| | | production | | | of | atoms of alkyl | | Formula | of formulae 3 |
| | | conditions | | | protective | groups in | | 3/formula 4 | and 4 in |
| | Elastic | Raw | X | Y | layer | formula 4 | | (analytical | protective layer |
| Example | layer | material | (sccm) | (sec) | (nm) | (analytical value) | Inferred R in formula 1 | value) | (molar fraction) |
| 11 | 1b-C | E | 3.0 | 120 | 250 | 1.4 | CH₃, C₂H₅ | 0.52 | 0.96 |
| 12 | 1b-B | F | 3.0 | 120 | 250 | 1.8 | CH₃, C₃H₇ | 0.58 | 0.98 |
| 13 | 1b-A | G | 3.0 | 120 | 250 | 2.2 | CH₃, C₄H₉ | 0.67 | 0.96 |
| 14 | 1b-A | H | 3.0 | 120 | 250 | 2.5 | C₂H₅, C₃H₇ | 0.69 | 0.95 |
| 15 | 1b-C | I | 3.0 | 120 | 250 | 2.9 | C₂H₅, C₄H₉ | 0.77 | 0.96 |
| 16 | 1b-B | J | 3.0 | 120 | 250 | 3.5 | C₃H₇, C₄H₉ | 0.89 | 0.96 |
| 17 | 1b-A | K | 3.0 | 120 | 250 | 1.9 | CH₃, C₂H₅, C₃H₇ | 0.66 | 0.97 |
| 18 | 1b-B | L | 3.0 | 120 | 250 | 2.1 | CH₃, C₂H₅, C₄H₉ | 0.64 | 0.96 |
| 19 | 1b-B | M | 3.0 | 120 | 250 | 2.6 | CH₃, C₃H₇, C₄H₉ | 0.70 | 0.97 |
| 20 | 1b-A | N | 3.0 | 120 | 250 | 2.9 | C₂H₅, C₃H₇, C₄H₉ | 0.78 | 0.95 |
| 21 | 1b-C | O | 3.0 | 120 | 250 | 2.3 | CH₃, C₂H₅, C₃H₇, C₄H₉ | 0.69 | 0.99 |

TABLE 8

| | Fogging evaluation | | | | Durability evaluation | |
|---|---|---|---|---|---|---|
| Example | R₁ | P₁ | R_{15,000} | P_{15,000} | Environment 1 | Environment 2 |
| 11 | A | A | B | B | B | B |
| 12 | A | A | B | B | B | B |
| 13 | A | A | A | A | A | A |
| 14 | A | A | A | A | A | A |
| 15 | A | A | A | A | A | A |
| 16 | A | A | B | B | B | B |
| 17 | A | A | B | B | B | B |
| 18 | A | A | A | A | A | A |
| 19 | A | A | A | A | A | A |
| 20 | A | A | A | A | A | A |
| 21 | A | A | A | A | A | A |

In each of Examples 11 to 21, the protective layer of the conductive roller is constituted of a zinc oxide film formed by using multiple raw materials, having the chemical bond represented by the formula 1 and the chemical bond represented by the formula 2, and containing the structure represented by the formula 3 and the structure represented by the formula 4. The use of the conductive roller as a developing roller was able to suppress fogging and showed no conspicuous chipping or falling of the protective layer. In addition, as in Examples 1 to 10, when the analytical value for the average number of carbon atoms of the alkyl groups in the composition represented by the formula 4 in the protective layer was 2.0 or more and 3.0 or less, particularly preferred results were obtained. It can be understood from the foregoing that even when multiple kinds of alkyl groups (R) represented by the formula 1 are simultaneously present in the protective film, compatibility between its abrasion resistance and flexibility can be achieved as long as the average number of carbon atoms of the alkyl groups in the entire film is 2.0 or more and 3.0 or less. It is to be noted that the total content of the respective compositions represented by the formula 3 and formula 4 in the protective layer in each of Examples 11 to 21 was 0.95 to 0.99 (molar fraction).

### Examples 22 to 32

Conductive rollers were each produced by the same method as that of Example 1 except that the kind of the elastic layer and the conditions for the production of the protective layer were changed as shown in Table 9. It is to be noted that Table 9 shows the results of the analyses of the protective layers and Table 10 shows the results of the evaluations of the rollers as developing rollers.

TABLE 9

| | | CVD | | | | Average number | | | |
|---|---|---|---|---|---|---|---|---|---|
| | | production | | | | of carbon atoms | | formula | Total content of |
| | | conditions | | | Thickness of | of alkyl groups in | | 3/formula 4 | formulae 3 and 4 |
| | Elastic | Raw | X | Y | protective layer | formula 4 | Inferred R in | (analytical | in protective layer |
| Example | layer | material | (sccm) | (sec) | (nm) | (analytical value) | formula 1 | value) | (molar fraction) |
| 22 | 1b-C | B | 7.0 | 25 | 50 | 2.0 | C₂H₅ | 2.2 | 0.97 |
| 23 | 1b-A | C | 2.2 | 25 | 50 | 3.0 | C₃H₇ | 0.80 | 0.96 |
| 24 | 1b-C | A | 7.0 | 50 | 100 | 1.0 | CH₃ | 2.1 | 0.95 |
| 25 | 1b-B | B | 7.0 | 50 | 100 | 2.0 | C₂H₅ | 2.2 | 0.96 |
| 26 | 1b-B | D | 2.2 | 50 | 100 | 4.0 | C₄H₉ | 2.3 | 0.98 |
| 27 | 1b-A | A | 7.0 | 480 | 1,000 | 1.0 | CH₃ | 2.1 | 0.95 |
| 28 | 1b-C | B | 7.0 | 480 | 1,000 | 2.0 | C₂H₅ | 2.2 | 0.98 |
| 29 | 1b-A | C | 2.2 | 480 | 1,000 | 3.0 | C₃H₇ | 2.3 | 0.99 |
| 30 | 1b-A | D | 2.2 | 480 | 1,000 | 4.0 | C₄H₉ | 2.3 | 0.97 |
| 31 | 1b-A | B | 7.0 | 530 | 1,100 | 2.0 | C₂H₅ | 2.2 | 0.96 |
| 32 | 1b-B | C | 2.2 | 530 | 1,100 | 3.0 | C₃H₇ | 2.3 | 0.98 |

TABLE 10

| | Fogging evaluation | | | | Durability evaluation | |
|---|---|---|---|---|---|---|
| Example | R₁ | P₁ | R_{15,000} | P_{15,000} | Environment 1 | Environment 2 |
| 22 | A | A | A | A | B | B |
| 23 | A | A | A | A | B | B |
| 24 | A | A | B | B | B | B |
| 25 | A | A | A | A | A | A |
| 26 | A | A | B | B | B | B |
| 27 | A | A | B | B | B | B |
| 28 | A | A | A | A | A | A |
| 29 | A | A | A | A | A | A |
| 30 | A | A | B | B | B | B |
| 31 | A | A | A | A | B | B |
| 32 | A | A | A | A | B | B |

In each of Examples 22 to 32, the protective layer of the conductive roller is constituted of a zinc oxide film having the chemical bond represented by the formula 1 and the chemical bond represented by the formula 2, and containing the structure represented by the formula 3 and the structure represented by the formula 4.

In addition, the use of the conductive roller as a developing roller was able to suppress fogging and showed no conspicuous chipping or falling of the protective layer. In particular, when the analytical value for the average number of carbon atoms of the alkyl groups in the composition represented by the formula 4 in the protective layer was 2.0 or more and 3.0 or less and the thickness of the protective layer was 100 nm or more and 1,000 nm or less, more preferred results were obtained. This is because when the analytical value and the thickness fall within the ranges, compatibility between the flexibility and durability of the protective layer 1c can be realized. It is to be noted that the results of the evaluations of the developing rollers the protective layers 1c of which each have a thickness of 250 nm are as shown in Tables 6 and 8.

It is to be noted that the total content of the structure represented by the formula 3 and the structure represented by the formula 4 in the protective layer of each of Examples 22 to 32 was 0.95 to 0.99 (molar fraction).

### Examples 33 to 46

Conductive rollers were each produced by the same method as that of Example 1 except that the kind of the elastic layer and the conditions for the production of the protective layer were changed as shown in Table 11. It is to be noted that Table 11 shows the results of the analyses of the protective layers and Table 12 shows the results of the evaluations of the rollers as developing rollers.

TABLE 11

| | | CVD | | | | Average number | | | |
|---|---|---|---|---|---|---|---|---|---|
| | | production | | | | of carbon atoms | | formula | Total content of |
| | | conditions | | | Thickness of | of alkyl groups in | | 3/formula 4 | formulae 3 and 4 |
| | Elastic | Raw | X | Y | protective layer | formula 4 | Inferred R in | (analytical | in protective layer |
| Example | layer | material | (sccm) | (sec) | (nm) | (analytical value) | formula 1 | value) | (molar fraction) |
| 33 | 1b-B | B | 8.5 | 120 | 250 | 2.0 | C₂H₅ | 0.23 | 0.97 |
| 34 | 1b-A | C | 1.2 | 120 | 250 | 3.0 | C₃H₇ | 0.25 | 0.94 |
| 35 | 1b-B | A | 8.3 | 120 | 250 | 1.0 | CH₃ | 0.33 | 0.95 |
| 36 | 1b-A | B | 8.3 | 120 | 250 | 2.0 | C₂H₅ | 0.33 | 0.97 |
| 37 | 1b-B | C | 1.4 | 120 | 250 | 3.0 | C₃H₇ | 0.34 | 0.96 |
| 38 | 1b-A | D | 1.4 | 120 | 250 | 4.0 | C₄H₉ | 0.34 | 0.95 |
| 39 | 1b-A | A | 6.8 | 120 | 250 | 1.0 | CH₃ | 2.9 | 0.98 |
| 40 | 1b-B | B | 6.8 | 120 | 250 | 2.0 | C₂H₅ | 3.1 | 0.97 |
| 41 | 1b-A | C | 2.8 | 120 | 250 | 3.0 | C₃H₇ | 3.1 | 0.98 |
| 42 | 1b-B | D | 2.8 | 120 | 250 | 4.0 | C₄H₉ | 3.1 | 0.96 |
| 43 | 1b-B | B | 6.5 | 120 | 250 | 2.0 | C₂H₅ | 3.4 | 0.98 |
| 44 | 1b-A | C | 2.9 | 120 | 250 | 3.0 | C₃H₇ | 3.4 | 0.97 |
| 45 | 1b-A | B | 6.3 | 120 | 250 | 2.0 | C₂H₅ | 4.1 | 0.98 |
| 46 | 1b-B | C | 3.0 | 120 | 250 | 3.0 | C₃H₇ | 4.2 | 0.98 |

TABLE 12

| | Fogging evaluation | | | | Durability evaluation | |
|---|---|---|---|---|---|---|
| Example | R₁ | P₁ | R_{15,000} | P_{15,000} | Environment 1 | Environment 2 |
| 33 | A | A | A | A | A | A |
| 34 | A | A | A | A | A | A |
| 35 | A | A | B | B | B | B |
| 36 | A | A | A | A | A | A |
| 37 | A | A | A | A | A | A |
| 38 | A | A | B | B | B | B |
| 39 | A | A | B | B | B | B |
| 40 | A | A | A | A | A | A |
| 41 | A | A | A | A | A | A |
| 42 | A | A | B | B | B | B |
| 43 | A | A | A | A | A | A |
| 44 | A | A | A | A | A | A |
| 45 | A | A | A | A | A | A |
| 46 | A | A | A | A | A | A |

In each of Examples 33 to 46, the protective layer of the conductive roller is constituted of a zinc oxide film formed by using a single raw material, having the chemical bond represented by the formula 1 and the chemical bond represented by the formula 2, and containing the structure represented by the formula 3 and the structure represented by the formula 4. The use of the conductive roller as a developing roller suppressed fogging and showed no conspicuous chipping or falling of the protective layer. However, Examples 33 and 34 each had a smaller content of the composition represented by the formula 3 in the protective layer than those of Examples 36, 37, 40, and 41. Accordingly, Examples 33 and 34 each had lower charge-providing performance than that of any such example, and each had a somewhat thinner image density than that of any such example. In addition, Examples 43 to 46 each had a smaller content of the structure represented by the formula 4 capable of suppressing hygroscopic property than those of Examples 36, 37, 40, and 41. Accordingly, under a high-humidity environment, Examples 43 to 46 each had lower charge-providing performance than that of any such example, and each had a somewhat thinner image density than that of any such example owing to moisture absorption.

It was understood from the foregoing results that when the analytical value for the average number of carbon atoms of the alkyl groups in the structure represented by the formula 4 in the protective layer was 2.0 or more and 3.0 or less, and the analytical value for the ratio formula 3/formula 4 was 0.33 or more and 3.1 or less, more preferred results were obtained. This is because of the following reasons. When the average number of carbon atoms of the alkyl groups in the formula 4 falls within the range, compatibility between the abrasion resistance and flexibility of the protective layer can be achieved. In addition, when the analytical value for the ratio formula 3/formula 4 is 0.33 or more and 3.1 or less, compatibility between high charge-providing performance and low hygroscopic property in the protective layer can be achieved.

It is to be noted that the total content of the structure represented by the formula 3 and the structure represented by the formula 4 in the protective layer of each of Examples 33 to 46 was 0.94 to 0.98 (molar fraction).

### Examples 47 to 50

Conductive rollers were each produced by the same method as that of Example 1 except that the kind of the elastic layer and the conditions for the production of the protective layer were changed as shown in Table 13. It is to be noted that Table 13 shows the results of the analyses of the protective layers and Table 14 shows the results of the evaluations of the rollers as developing rollers. In addition, Table 13 and 14 also show the results of the evaluations of Example 13 for the comparison with those results of the evaluations.

TABLE 13

| | | CVD | | | | Average number | | | |
|---|---|---|---|---|---|---|---|---|---|
| | | production | | | Thickness of | of carbon atoms | | formula | Total content of |
| | | conditions | | | protective | of alkyl groups in | | 3/formula 4 | formulae 3 and 4 |
| | Elastic | Raw | X | Y | layer | formula 4 | Inferred R | (analytical | in protective layer |
| Example | layer | material | (sccm) | (sec) | (nm) | (analytical value) | in formula 1 | value) | (molar fraction) |
| 13 | 1b-A | G | 3.0 | 120 | 250 | 2.2 | CH₃, C₄H₉ | 0.67 | 0.96 |
| 47 | 1b-A | P | 3.0 | 120 | 250 | 1.5 | CH₃, C₄H₉ | 0.25 | 0.95 |
| 48 | 1b-A | Q | 3.0 | 120 | 250 | 3.0 | CH₃, C₄H₉ | 2.0 | 0.95 |
| 49 | 1b-A | R | 3.0 | 120 | 250 | 3.2 | CH₃, C₄H₉ | 3.0 | 0.97 |
| 50 | 1b-B | S | 7.0 | 120 | 250 | 1.6 | CH₃, C₂H₅ | 2.2 | 0.85 |

TABLE 14

| | Fogging evaluation | | | | Durability evaluation | |
|---|---|---|---|---|---|---|
| Example | R₁ | P₁ | R_{15,000} | P_{15,000} | Environment 1 | Environment 2 |
| 13 | A | A | A | A | A | A |
| 47 | A | A | B | B | B | B |
| 48 | A | A | A | A | A | A |
| 49 | A | A | B | B | B | B |
| 50 | A | A | B | B | B | B |

In each of Examples 13 and 47 to 49, the protective layer of the conductive roller is constituted of a zinc oxide film formed by using multiple raw materials, having the bond represented by the formula 1 and the bond represented by the formula 2, and containing the structure represented by the formula 3 and the structure represented by the formula 4. The use of the conductive roller as a developing roller suppressed fogging and showed no conspicuous chipping or falling of the protective layer. As in Examples 33 to 46 described above, when the analytical value for the average number n of carbon atoms of the alkyl groups in the composition represented by the formula 4 in the protective layer was 2.0 or more and 3.0 or less, and the analytical value for the ratio formula 3/formula 4 was 0.33 or more and 3.1 or less, more preferred results were obtained. It is to be noted that the total content of the structure represented by the formula 3 and the structure represented by the formula 4 in the protective layer of each of Examples 13 and 47 to 49 was 0.95 to 0.97 (molar fraction).

In addition, in Example 50, the protective layer of the conductive roller is constituted of a zinc oxide film having the bond represented by the formula 1 and the bond represented by the formula 2, and containing the structure represented by the formula 3 and the structure represented by the formula 4. The use of the conductive roller as a developing roller suppressed fogging and showed no conspicuous chipping or falling of the protective layer. It is to be noted that the total content of the structure represented by the formula 3 and the structure represented by the formula 4 in the protective layer was 0.85 (molar fraction).

### Examples 51 to 53

Conductive rollers were each produced by the same method as that of Example 1 except that: an elastic layer shown in Table 15 was used as the elastic layer; and a protective layer produced by the following method was used as the protective layer.

(Method of Producing Protective Layer)

(Protective Layer Production Method 2: Method of Producing Alkoxy Group-Containing Zinc Oxide Film Based on Sol-Gel Method)

Added to 100 parts by mass of an alkoxyzinc as a raw material were 25 parts by mass of an alcohol corresponding to the alkoxy moiety of the alkoxyzinc For example, when diisopropoxyzinc is used as the alkoxyzinc, the alcohol to be used is isopropanol) and 500 parts by mass of water. The contents were heated and mixed at 150° C. for 2 hours, followed by cooling. The solution for forming a protective layer was charged into a dipping apparatus. After that, a roller provided with an elastic layer was immersed in the solution with the dipping apparatus, and then the resultant was air-dried for 30 minutes and heated at 150° C. for 2 hours, followed by air-drying for 1 hour. The foregoing operation was repeated 4 times. Thus, the protective layer 1c was produced.

It is to be noted that C: diisopropoxyzinc was used as the alkoxyzinc as a raw material in each of Example 51 and Example 53, and D: di-tert-butoxyzinc was used as the alkoxyzinc in Example 52. It is to be noted that Table 15 shows the results of the analyses of the protective layers 1c and Table 16 shows the results of the evaluations of the rollers as developing rollers. In addition, Z in sol-gel production conditions shown in Table 15 represents the number of times of application of the solution for forming a protective layer to an elastic roller.

TABLE 15

| | | Sol-gel production | | | Average number of | | formula | Total content of |
|---|---|---|---|---|---|---|---|---|
| | | conditions | | Thickness of | carbon atoms of alkyl | | 3/formula 4 | formulae 3 and 4 in |
| | Elastic | Raw | | protective layer | groups in formula 4 | Inferred R | (analytical | protective layer |
| Example | layer | material | Z (time(s)) | (nm) | (analytical value) | in formula 1 | value) | (molar fraction) |
| 51 | 1b-A | C | 4 | 250 | 3.0 | C₃H₇ | 2.1 | 0.95 |
| 52 | 1b-A | D | 4 | 250 | 4.0 | C₄H₉ | 2.2 | 0.98 |
| 53 | 1b-C | C | 1 | 100 | 3.0 | C₃H₇ | 2.1 | 0.98 |

TABLE 16

| | Fogging evaluation | | | | Durability evaluation | |
|---|---|---|---|---|---|---|
| Example | R₁ | P₁ | R_{15,000} | P_{15,000} | Environment 1 | Environment 2 |
| 51 | A | A | A | A | A | A |
| 52 | A | A | B | B | B | B |
| 53 | A | A | A | A | A | A |

As is apparent from Examples 51 to 53, even when an alkoxy group-containing zinc oxide film was produced by the sol-gel method as the protective layer production method 2, as in the method of producing an alkoxy group-containing zinc oxide film with a CVD apparatus as the protective layer production method 1 in each of Examples 1 to 50, no conspicuous chipping or falling of the protective layer was observed, and good results were obtained in the fogging evaluation and the durability evaluation.

### Comparative Examples 1 to 3

Conductive rollers (elastic rollers each formed of a mandrel and an elastic layer) were each produced in the same manner as in Example 1 except that: the elastic layer was changed to any one of those shown in Table 17; and the protective layer was not provided. It is to be noted that Table 18 shows the results of the evaluations of the rollers as developing rollers.

### Comparative Examples 4 and 5

Conductive rollers were each produced in the same manner as in Example 1 except that: the elastic layer was changed to any one of those shown in Table 17; and a powder of zinc oxide (trade name: FZO-50; manufactured by ISHIHARA SANGYO KAISHA, LTD.) was applied instead of the protective layer onto the peripheral surface of the elastic layer. It is to be noted that Table 18 shows the results of the evaluations of the rollers as developing rollers.

### Comparative Examples 6 and 7

Conductive rollers were each produced in the same manner as in Example 1 except that: the elastic layer was changed to any one of those shown in Table 17; and a zinc oxide film free of any alkoxy group was provided as the protective layer on the outer peripheral surface of the elastic layer by the plasma CVD method. Table 17 shows their production conditions. In addition, Table 18 shows the results of the evaluations of the rollers as developing rollers. It is to be noted that when the elemental analysis of the protective layer of each of Comparative Examples 6 and 7 was performed with a scanning X-ray photoelectron spectrometer (trade name: PHI5000 VersaProbe; manufactured by ULVAC-PHI, Inc.), a zinc element and an oxygen element were detected, but a carbon element was not detected. This shows that the protective layer of each of Comparative Examples 6 and 7 is free of the bond represented by the formula 1 and is formed only of the bond represented by the formula 2.

TABLE 17

| | | | | | Thickness |
|---|---|---|---|---|---|
| | | CVD production | | | of |
| | | conditions | | | protective |
| Comparative | Elastic | Raw | X | Y | layer |
| Example | layer | material | (sccm) | (sec) | (nm) |
| 1 | 1b-A | — | — | — | — |
| 2 | 1b-B | — | — | — | — |
| 3 | 1b-C | — | — | — | — |
| 4 | 1b-A | — | — | — | — |
| 5 | 1b-B | — | — | — | — |
| 6 | 1b-B | A | 100 | 120 | 250 |
| 7 | 1b-C | A | 100 | 360 | 750 |

TABLE 18

| Compar- | | | | | | |
|---|---|---|---|---|---|---|
| ative | Fogging evaluation | | | | Durability evaluation | |
| Example | R₁ | P₁ | R_{15,000} | P_{15,000} | Environment 1 | Environment 2 |
| 1 | B | B | C | C | B | B |
| 2 | B | B | C | C | B | B |
| 3 | B | B | C | C | B | B |
| 4 | C | C | C | C | C | C |
| 5 | C | C | C | C | C | C |
| 6 | C | C | C | C | C | C |
| 7 | C | C | C | C | C | C |

When the conductive rollers obtained in Comparative Examples 1 to 3 were each used as a developing roller, the surface of the developing roller was an elastic layer, i.e., a resin or a rubber, and hence the developing roller was inferior in charge-providing performance to the examples described above and partial chipping was observed in the surface of the developing roller. In addition, toner sticking starting from the chipped portion in the surface of the developing roller as a starting point was observed in the entire surface, and hence fogging after long-term use (after the output of 15,000 images) occurred to an extremely large extent.

When the conductive rollers obtained in Comparative Examples 4 and 5 were each used as a developing roller, initial fogging occurred owing to the moisture absorption of zinc oxide to a larger extent than those of the examples described above. In addition, the zinc oxide powder was used as the protective layer of the developing roller, and hence the falling of the zinc oxide powder was observed throughout the use. Further, chipping occurred in the surface of the developing roller exposed by the falling of the zinc oxide powder during long-term use. In addition, toner sticking starting from the chipped portion as a starting point was caused in the entire surface, and hence fogging occurred to an extremely large extent.

When the conductive rollers obtained in Comparative Examples 6 and 7 were each used as a developing roller, initial fogging occurred owing to the moisture absorption of the zinc oxide film free of any alkoxy group to a larger extent than those of the examples described above. In addition, the zinc oxide film was used as the protective layer of the developing roller, and hence the followability of the protective layer to the elastic layer became poor and the falling of the protective layer 1c due to peeling from the elastic layer was observed. Accordingly, chipping occurred in the surface of the developing roller exposed by the falling of the zinc oxide film during long-term use. In addition, toner sticking starting from the chipped portion as a starting point was caused in the entire surface, and hence fogging occurred to an extremely large extent.

<Charging Roller>

### Examples 54 to 58

With regard to Examples 54 to 57, conductive rollers were produced in the same manners as in Examples 1, 6, 29, and 30, respectively except that the length of the mandrel 1a in its axial direction was set to 252 mm, the thickness of the elastic layer was set to 1.25 mm, and the length of the elastic layer in the axial direction of the mandrel was set to 228 mm. With regard to Example 58, a conductive roller was produced in the same manner as in Example 1 except the following. The kind of the elastic layer and the conditions for the production of the protective layer were changed as shown in Table 19. In addition, the length of the mandrel 1a in its axial direction was set to 252 mm, the thickness of the elastic layer was set to 1.25 mm, and the length of the elastic layer in the axial direction of the mandrel was set to 228 mm.

The produced conductive rollers were subjected as charging rollers to the following evaluations. It is to be noted that Table 19 shows the results of the analyses of the protective layers 1c and Table 20 shows the results of the evaluation of the rollers as charging rollers.

(Evaluation)

Evaluation of Protective Layer for its Physical Properties

The methods employed at the time of the evaluations of a developing roller described above were similarly employed for the thickness of the protective layer, the average number of carbon atoms of the alkyl groups in the formula 4, the ratio formula 3/formula 4 (analytical value), and the total content of the structure represented by the formula 3 and the structure represented by the formula 4 in the protective layer. It is to be noted that evaluations paying attention to the structure represented by the formula 3 and the structure represented by the formula 4 in the protective layer were performed here. In addition, the alkyl group (R) in the chemical bond represented by the formula 1 in the protective layer was inferred from the value for the average number of carbon atoms in the formula 4.

Image Evaluation of Charging Roller

The produced conductive rollers were each incorporated as a charging roller into the cartridge for magenta of a reconstructed machine of a color laser printer: LBP7700C (trade name; manufactured by Canon Inc.). In addition, a photosensitive member to be mounted on the cartridge was perforated with 5 holes reaching its metal substrate and each having a diameter of 0.3 mm by using a metal needle. A pinhole leak was evaluated as described below by printing a halftone image with the reconstructed machine of the laser printer in an environment having a temperature of 35° C. and a relative humidity of 80% through the application of a DC voltage of −1,000 V to the photosensitive member. It is to be noted that the color laser printer was reconstructed so that an arbitrary voltage could be applied to the photosensitive member.

A: No pinhole leak is observed in the image.
B: A dot-like pinhole leak is observed in the image.
C: A linear pinhole leak is observed in the image.

Table 20 shows the results of the evaluation of the rollers as charging rollers.

TABLE 19

| | | CVD | | | | Average number | | | |
|---|---|---|---|---|---|---|---|---|---|
| | | production | | | | of carbon atoms | | Formula | Total content of |
| | | conditions | | | Thickness of | of alkyl groups in | | 3/formula 4 | formulae 3 and 4 |
| | Elastic | Raw | X | Y | protective layer | formula 4 | Inferred R | (analytical | in protective layer |
| Example | layer | material | (sccm) | (sec) | (nm) | (analytical value) | in formula 1 | value) | (molar fraction) |
| 54 | 1b-A | A | 7.0 | 120 | 250 | 1.0 | CH₃ | 2.1 | 0.97 |
| 55 | 1b-C | B | 7.0 | 120 | 250 | 2.0 | C₂H₅ | 2.2 | 0.98 |
| 56 | 1b-A | C | 2.2 | 480 | 1,000 | 3.0 | C₃H₇ | 2.3 | 0.99 |
| 57 | 1b-A | D | 2.2 | 480 | 1,000 | 4.0 | C₄H₉ | 2.3 | 0.97 |
| 58 | 1b-C | C | 2.2 | 25 | 50 | 3.0 | C₃H₇ | 2.3 | 0.94 |

TABLE 20

| | Pinhole leak |
|---|---|
| Example | evaluation |
| 54 | A |
| 55 | A |
| 56 | A |
| 57 | A |
| 58 | A |

In each of Examples 54 to 58, the protective layer of the conductive roller is constituted of a zinc oxide film having the bond represented by the formula 1 and the bond represented by the formula 2, and containing the structure represented by the formula 3 and the structure represented by the formula 4. The use of the conductive roller as a charging roller showed no pinhole leak. It is to be noted that as the charging roller does not receive rubbing as large as that of a developing roller during its use, even when the thickness of the protective layer is less than 100 nm like Example 58, a preferred result is obtained throughout the use. It is to be noted that the total content of the structure represented by the formula 3 and the structure represented by the formula 4 in the protective layer of each of Examples 54 to 58 was 0.94 to 0.99 (molar fraction).

### Examples 59 to 62

Conductive rollers of Examples 59 to 62 were produced in the same manners as in Examples 5, 10, 35, and 41, respectively except that the length of the mandrel 1a in its axial direction was set to 252 mm, the thickness of the elastic layer was set to 1.25 mm, and the length of the elastic layer in the axial direction of the mandrel was set to 228 mm.

The produced conductive rollers were subjected as charging rollers to evaluations. It is to be noted that Table 21 shows the results of the analyses of the protective layers 1c and Table 22 shows the results of the evaluations of the rollers as charging rollers.

TABLE 21

| | | CVD | | | | Average number | | | |
|---|---|---|---|---|---|---|---|---|---|
| | | production | | | | of carbon atoms | | Formula | Total content of |
| | | conditions | | | Thickness of | of alkyl groups in | | 3/formula 4 | formulae 3 and 4 |
| | Elastic | Raw | X | Y | protective layer | formula 4 | Inferred R in | (analytical | in protective layer |
| Example | layer | material | (sccm) | (sec) | (nm) | (analytical value) | formula 1 | value) | (molar fraction) |
| 59 | 1b-B | B | 7.0 | 120 | 250 | 2.0 | C₂H₅ | 2.2 | 0.97 |
| 60 | 1b-C | D | 2.2 | 120 | 250 | 4.0 | C₄H₉ | 2.3 | 0.98 |
| 61 | 1b-B | A | 8.3 | 120 | 250 | 1.0 | CH₃ | 0.33 | 0.95 |
| 62 | 1b-A | C | 2.8 | 120 | 250 | 3.0 | C₃H₇ | 3.1 | 0.98 |

TABLE 22

| | Pinhole leak |
|---|---|
| Example | evaluation |
| 59 | A |
| 60 | A |
| 61 | A |
| 62 | A |

In each of Examples 59 to 62, the protective layer of the conductive roller is constituted of a zinc oxide film having the bond represented by the formula 1 and the bond represented by the formula 2, and containing the structure represented by the formula 3 and the structure represented by the formula 4. The use of the conductive roller as a charging roller showed no pinhole leak. This is because when the analytical value for the ratio formula 3/formula 4 in the protective layer is 0.33 or more and 3.1 or less, compatibility between high charge-providing performance and low hygroscopic property can be achieved. It is to be noted that the total content of the structure represented by the formula 3 and the structure represented by the formula 4 in the protective layer of each of Examples 59 to 62 was 0.95 to 0.98 (molar fraction).

### Comparative Examples 8 to 14

Conductive rollers of Comparative Examples 8 to 14 were produced in the same manners as in Comparative Examples 1 to 7, respectively except that, in the conductive roller, the length of the mandrel 1a in its axial direction was set to 252 mm, the thickness of the elastic layer was set to 1.25 mm, and the length of the elastic layer in the axial direction of the mandrel was set to 228 mm. The produced conductive rollers were subjected as charging rollers to evaluations. It is to be noted that Table 23 shows the results of the evaluations of the rollers as charging rollers.

TABLE 23

| Comparative | Pinhole leak |
|---|---|
| Example | evaluation |
| 8 | B |
| 9 | B |
| 10 | B |
| 11 | C |
| 12 | C |
| 13 | C |
| 14 | C |

The use of the conductive roller of each of Comparative Examples 8 to 14 as a charging roller showed a pinhole leak. Possible reasons for the foregoing are as described below. Each of Comparative Examples 8 to 10 had no protective layer and its conductive elastic layer was exposed, and hence the pinhole leak could not be suppressed. In addition, the protective layer of each of Comparative Examples 11 to 14 absorbed moisture under a high-humidity environment and hence its surface resistance reduced.

(Evaluation of Protective Layer for its Water-Absorbing Property)

The following test piece was produced for each of the protective layers according to the present invention each having the chemical bonds represented by the formula 1 and formula 2, and each containing the structures represented by the formula 3 and formula 4 (1c-A to 1c-D of Table 24), and a zinc oxide film free of the chemical bond represented by the formula 1 and the structure represented by the formula 4. The amount of water absorption of the test piece in an environment having a temperature of 20° C. and a relative humidity of 70% was measured. The test piece was produced on a 1-cm square thin plate made of iron with a CVD apparatus under conditions shown in Table 24. It is to be noted that the amount of water absorption was measured with a thermogravimetric analyzer (manufactured by Rigaku Denki Co., Ltd., trade name: TG8120) in the presence of dry air at 300° C. Table 24 shows the results of the measurement.

TABLE 24

| | CVD | | | | Average number | | | Total content of | |
|---|---|---|---|---|---|---|---|---|---|
| | production | | | | of carbon atoms | | Formula | formulae 3 and 4 | |
| | conditions | | | Thickness of | of alkyl groups in | | 3/formula 4 | in protective | Water |
| Protective layer | Raw | X | Y | protective layer | formula 4 | Inferred R in | (analytical | layer | content |
| name | material | (sccm) | (sec) | (nm) | (analytical value) | formula 1 | value) | (molar fraction) | (mass %) |
| 1c-A | A | 7.0 | 100 | 250 | 1.0 | CH₃ | 2.2 | 0.99 | 0.5 |
| 1c-B | B | 7.0 | 100 | 250 | 2.0 | C₂H₅ | 2.1 | 0.98 | 0.4 |
| 1c-C | C | 2.2 | 100 | 250 | 3.0 | C₃H₇ | 2.1 | 0.98 | 0.4 |
| 1c-D | D | 2.2 | 100 | 250 | 4.0 | C₄H₉ | 2.2 | 0.98 | 0.3 |
| Zinc oxide | A | 100 | 100 | 250 | — | — | — | — | 3.2 |

It can be understood from the foregoing results that the protective layer to be used in the present invention is more excellent in low hygroscopic property than a zinc oxide film free of the chemical bond represented by the formula 1 and the structure represented by the formula 4. Accordingly, the member for electrophotography of the present invention having the protective layer can suppress a reduction in charge-providing performance due to moisture absorption while maintaining its high charge-providing performance derived from the zinc oxide moiety. As a result, image output independent of a humidity environment can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-226869, filed Oct. 14, 2011, which is hereby incorporated by reference herein in its entirety.

What is claimed is:

1. A member for electrophotography, comprising:
a mandrel;
an elastic layer; and
a protective layer,
wherein the protective layer comprises a zinc oxide film having a chemical bond represented by the following formula 1 and a chemical bond represented by the following formula 2:
Zn—O—R] (Formula 1)
in the formula 1), R represents an alkyl group
O—Zn—O (Formula 2).

2. The member for electrophotography according to claim 1, wherein the alkyl group R in the formula 1 has 1 or more and 4 or less carbon atoms.

3. The member for electrophotography according to claim 1, wherein the protective layer has a thickness of 100 nm or more and 1,000 nm or less.

4. The member for electrophotography according to claim 1, wherein the elastic layer comprises an epichlorohydrin-ethylene oxide-allyl glycidyl ether terpolymer or a silicone rubber.

5. The member for electrophotography according to claim 1, wherein:
the elastic layer has a stacked structure in which a first elastic layer and a second elastic layer are stacked in the mentioned order from the mandrel side;
the first elastic layer comprises an epichlorohydrin-ethylene oxide-allyl glycidyl ether terpolymer or a silicone rubber; and
the second elastic layer comprises a urethane resin.

6. A process cartridge, comprising the member for electrophotography according to claim 1, the process cartridge being attachable to and detachable from an electrophotographic apparatus.

7. An electrophotographic apparatus, comprising the member for electrophotography according to claim 1.

8. A member for electrophotography, comprising:
a mandrel;
an elastic layer; and
a protective layer,
wherein the protective layer comprises a zinc oxide film containing a structure represented by the following formula 3 and a structure represented by the following formula 4:
ZnO_{2/2} (Formula 3)
ZnO_{1/2}(OCₙH₂ₙ₊₁) (Formula 4)
in the formula 4, n represents an average number of carbon atoms in the structure represented by the formula 4 in the zinc oxide film and represents a real number of 1 or more.
